(19) United States
(12) Patent Application Publication
(10) Pub. No.: US 2013/0161177 A1
(43) Pub. Date: Jun. 27, 2013

(54) TOUCH PANEL

(71) Applicants: Wan Jae Lee, Gyunggi-do (KR); Ha Yoon Song, Gyunggi-do (KR)

(72) Inventors: Wan Jae Lee, Gyunggi-do (KR); Ha Yoon Song, Gyunggi-do (KR)

(73) Assignee: SAMSUNG ELECTRO-MECHANICS CO., LTD., Gyunggi-do (KR)

(21) Appl. No.: 13/409,876

(22) Filed: Mar. 1, 2012

(30) Foreign Application Priority Data
Dec. 21, 2011 (KR) 1020110139326

(51) Int. Cl. H01H 1/10

(52) U.S. Cl. 200/512

(57) ABSTRACT

Disclosed herein is a touch panel including a window, a transparent substrate, a first electrode wiring formed on one surface of the transparent substrate, a second electrode wiring formed on the other surface of the transparent substrate, an adhesive layer attaching one surface of the window to one surface of the transparent substrate, a connection wiring formed on one surface of the window and electrically connected to the first electrode wiring, and a flexible printed circuit board (FPCB) electrically connected to the second electrode wiring and the connection wiring.

### CROSS REFERENCE TO RELATED APPLICATION

This application claims the benefit of Korean Patent Application No. 10-2011-0139326, filed on Dec. 21, 2011, entitled “Touch Panel”, which is hereby incorporated by reference in its entirety into this application.

### BACKGROUND OF THE INVENTION

1. Technical Field

The present invention relates to a touch panel.

2. Description of the Related Art

As computers using a digital technology have advanced, auxiliary equipment of computers has also been developed, and personal computers, portable transmission devices, and other personal dedicated information processing devices perform text and graphic processing using various input devices such as a keyboard, a mouse, and the like.

However, due to the rapid progress being made in an information-oriented society, the purpose of computers have gradually extended, such that it is difficult to effectively drive products only with a keyboard and mouse currently serving as input devices. Thus, the necessity of a device which can be simply manipulated, cause less malfunction, and allow users to easily input information is increasing.

Also, consumers' interest in technologies regarding input devices are transitioning, beyond the level of satisfying a general function, but demanding high reliability, durability, progressiveness, design and process-related techniques, and the like, and in order to achieve such purposes, a touch panel has been developed as an input device available for inputting information such as text, graphics, and the like.

A touch panel is an implement that is installed on a display plane of an image display device including a flat panel display device such as an electronic notebook, a liquid crystal display (LCD), a plasma display panel (PDP), an electroluminescence (EL), or the like, and a cathode ray tube (CRT), and allows users to select desired information while viewing an image display device.

Meanwhile, touch panels are classified into a resistive type touch panel, a capacitive type touch panel, an electro-magnetic type touch panel, a surface acoustic wave (SAW) type touch panel, and an infrared type touch panel. The various types of touch panels are employed in electronic products in consideration of signal amplification, a difference in resolution, a difference in designing and processing technique, optical characteristics, electrical characteristics, mechanical characteristics, environment-resistance characteristics, input characteristics, durability, and economic feasibility, and currently, the resistive type touch panel and the capacitive type touch panel are widely used.

Meanwhile, the prior art touch panel will be described with reference to Korean Patent Laid Open Publication No. 10-2011-0020826. In the prior art, in order to attach a flex circuit to both sides of a touch sensor panel, a flex circuit is separated into a first adhesion region and a second adhesion region and separately attached to both sides of the touch sensor panel. Here, the portion of the flex circuit, from which the first adhesion region and the second adhesion region are separated, is severely bent and causes cracks in the flex circuit. Also, in order to attach the flex circuit to both sides of the touch sensor panel, the first adhesion region of the flex circuit is attached to one side of the touch sensor panel, the touch sensor panel is reversed, and then, the second adhesion region of the flex circuit is attached to the other side. Thus, the process of attaching the touch sensor panel to the flex circuit is complicated, and a process of applying an anisotropic conductive film (ACF) to attach the touch sensor panel to the flex circuit should be performed at least two or more times.

### SUMMARY OF THE INVENTION

The present invention has been made in an effort to provide a touch panel in which a connection wiring, to be connected with electrode wirings formed on both sides of a transparent substrate, is formed on one face of a window to thereby electrically connect a flexible printed circuit board (FPCB) to the electrode wirings without having to greatly bend the FPCB.

According to a preferred embodiment of the present invention, there is provided a touch panel including: a window; a transparent substrate; a first electrode wiring formed on one surface of the transparent substrate; a second electrode wiring formed on the other surface of the transparent substrate; an adhesive layer attaching one surface of the window to one surface of the transparent substrate; a connection wiring formed on one surface of the window and electrically connected to the first electrode wiring; and a flexible printed circuit board (FPCB) electrically connected to the second electrode wiring and the connection wiring.

The connection wiring may be attached to an anisotropic conductive film (ACF) or an anisotropic conductive adhesive (ACA) so as to be electrically connected to the first electrode wiring.

The FPCB may be attached to an ACF or an ACA so as to be electrically connected to the second electrode wiring and the connection wiring.

The connection wiring may extend to the edge of the window so as to be protruded more to the outer side than the transparent substrate.

One surface of the FPCB may be electrically connected to the second electrode wiring and the connection wiring.

The FPCB may include: a base portion; and two protrusions protruded from both sides of the base portion.

One end of the base portion may be electrically connected to the connection wiring, and one end of each of the two protrusions may be electrically connected to the second electrode wirings.

One end of the base portion may be electrically connected to the second electrode wiring, and one end of each of the two protrusions may be electrically connected to the connection wirings.

The adhesive layer may be an optical clear adhesive (OCA).

The touch panel may further include: a first electrode pattern formed on one surface of the transparent substrate; and a second electrode pattern famed on the other surface of the transparent substrate, wherein the first electrode wiring is connected to the first electrode pattern and the second electrode wiring is connected to the second electrode pattern.

The first electrode wiring may be integrally formed with the first electrode pattern, and the second electrode wiring may be integrally formed with the second electrode pattern.

The first and second electrode patterns may be made of copper (Cu), aluminum (Al), gold (Au), silver (Ag), titanium (Ti), palladium (Pd), chromium (Cr), or any combination thereof.

The first and second electrode patterns may be made of metallic silver generated by exposing and developing a silver halide emulsion layer.

### BRIEF DESCRIPTION OF THE DRAWINGS

FIG. 1 is a cross-sectional view of a touch panel according to a preferred embodiment of the present invention;

FIGS. 2 through 5 are bottom views and cross-sectional views illustrating a process of manufacturing the touch panel according to the preferred embodiment of the present invention; and

FIG. 6 is a bottom view of a touch panel according to another preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, and so on are used to distinguish one element from another element, and the elements are not defined by the above terms. In describing the present invention, a detailed description of related known functions or configurations will be omitted so as not to obscure the gist of the present invention.

Hereinafter, preferred embodiments of the present invention will be described in detail with reference to the accompanying drawings.

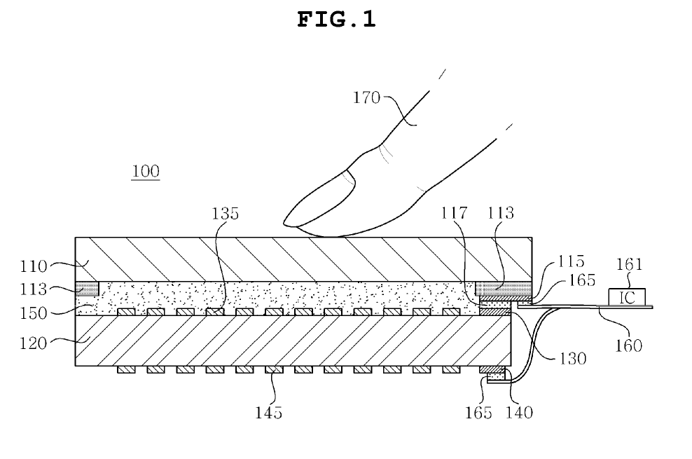

FIG. 1 is a cross-sectional view of a touch panel according to a preferred embodiment of the present invention;

As shown in FIG. 1, a touch panel 100 according to a preferred embodiment of the present invention may include a window 110, a transparent substrate 120, a first electrode wiring 130 formed on one surface of the transparent substrate 120, a second electrode wiring 140 formed on the other surface of the transparent substrate 120, an adhesion layer 150 bonding (or attaching) one surface of the window 110 to one surface of the transparent substrate 120, a connection wiring 115 formed on one surface of the window 110 and electrically connected to the first electrode wiring 130, and a flexible printed circuit board (FPCB) 160 electrically connected to the second electrode wiring 140 and the connection wiring 115.

The window 110 is provided at the outermost side of the touch panel 100 to protect the inner components, such as first and second electrode patterns 135 and 145 and the first and second electrode wirings 130 and 140, of the touch panel 100 and receives a touch applied by an input means 170 from the other surface (the opposite side of the side on which the connection wiring 115 is formed). Here, the window 110 may be made of glass, tempered glass, or the like, but the material of the window 110 is not particularly limited thereto. Also, a print region 113 may be formed on one surface of the window 110 to cover the first and second electrode wirings 130 and 140 or representing a logo, or the like. Here, the print region 113 may be formed through screen printing, sputtering, or the like. Meanwhile, the connection wiring 115 is formed on one surface of the window 110, and details of the connection wiring 115 will be described later.

The transparent substrate 120 serves to provide regions on which the first and second electrode patterns 135 and 145, the first and second electrode wirings 130 and 140, and the like, are to be formed. Here, the transparent substrate 120 is required to have bearing power sufficient to support the first and second electrode patterns 135 and 145, the first and second electrode wirings 130 and 140, and the like, and transparency allowing a user to recognize an image provided from the image display device. In consideration of the foregoing bearing power and transparency, the transparent substrate 120 may be made of polyethylene terephthalate (PET), polycarbonate (PC), polymethylmethacrylate (PMMA), polyethylene naphthalate (PEN), polyether sulfone (PES), a cyclic olefin copolymer (COC), a triacetylcellulose (TAC) film, a polyvinyl alcohol (PVA) film, a polyimide (PI) film, polystyrene (PS), biaxially oriented polystyrene (BOPS) (which contains K-resin), glass, tempered glass, or the like, but the present invention is not necessarily limited thereto.

Meanwhile, the first and second electrode patterns 135 and 145 may be formed on both surfaces of the transparent substrate 120. When the input means 170 applies a touch, the first and second electrode patterns 135 and 145 generate a signal to allow an integrated circuit (IC) 161 to recognize touch coordinates. In detail, the first electrode pattern 135 is formed on one surface of the transparent substrate 120, and the second electrode pattern 145 is formed on the other surface of the transparent substrate 120. Here, the first and second electrode patterns 135 and 145 may be made of copper (Cu), aluminum (Al), gold (Au), silver (Ag), titanium (Ti), palladium (Pd), chromium (Cr), or any combination thereof and may be configured as mesh patterns. In detail, preferably, the first and second electrode patterns 135 and 145 are made of copper (Cu), aluminum (Al), gold (Au), and silver (Ag) having high electric conductivity, but, of course, any metals having electric conductivity may be used as a material of the first and second electrode patterns 135 and 145. Also, when the first and second electrode patterns 135 and 145 are made of copper (Cu), preferably, the surfaces of the first and second electrode patterns 135 and 145 are blackened. Here, blackening refers to oxidizing the surfaces of the first and second electrode patterns 135 and 145 to extract (or educe) Cu₂O or CuO. Here, Cu₂O is brown, so it is called a brown oxide, and CuO is black, so it is called a black oxide. Thus, since the surfaces of the first and second electrode patterns 135 and 145 are blackened, light can be prevented from being reflected therefrom, and accordingly, visibility of the touch panel 100 can be enhanced.

Also, besides the foregoing metals, the first and second electrode patterns 135 and 145 may be made of metallic silver generated by exposing and developing a silver halide emulsion layer, indium tin oxide (ITO), PEDOT/PSS, carbon nanotube (CNT), graphene, zinc oxide (ZnO), Al-doped zinc oxide (AZO), or the like.

The first and second electrode wirings 130 and 140 are connected to the first and second electrode patterns 135 and 145 to receive electrical signals from the first and second electrode patterns 135 and 145. Here, the first and second electrode wirings 130 and 140 may be formed on regions corresponding to the print region 113 such that the user cannot recognize them. In detail, the first electrode wiring 130 is formed on one surface of the transparent substrate 120, and the second electrode wiring 140 may be formed on the other surface of the transparent substrate 120. Also, the first and second electrode wirings 130 and 140 may be made of copper (Cu), aluminum (Al), gold (Au), silver (Ag), titanium (Ti), palladium (Pd), chromium (Cr), or any combination thereof, having excellent electric conductivity. However, the present invention is not limited thereto and the first and second electrode wirings 130 and 140 may also be made of metallic silver generated by exposing and developing a silver halide emulsion layer, indium tin oxide (ITO), PEDOT/PSS, carbon nanotube (CNT), graphene, zinc oxide (ZnO), Al-doped zinc oxide (AZO), or the like. Also, the first electrode wiring 130 may be integrally formed with the first electrode pattern 135, and the second electrode wiring 140 may be integrally formed with the second electrode pattern 145, as necessary. In this manner, when the first and second electrode wirings 130 and 140 are integrally formed with the first and second electrode patterns 135 and 145, defective bonding (or attachment) between the first and second electrode wirings 130 and 140 and the first and second electrode patterns 135 and 145 can be prevented, a manufacturing process can be simplified, and a lead time can be shortened.

The adhesive layer 150 serves to attach one surface of the window 110 to one surface of the transparent substrate 120. Here, the adhesive layer 150 may be an optical clear adhesive (OCA)), but, of course, any types of adhesives known in the art may be used.

The connection wiring 115, formed on one surface of the window 110, serves to electrically connect the first electrode wiring 130 and the FPCB 160. In detail, the connection wiring 115 is attached to a first conductive adhesive material 117 such as an anisotropic conductive film (ACF), an anisotropic conductive adhesive (ACA), or the like, so as to be electrically connected to the first electrode wiring 130. Also, the connection wiring 115 is attached to a second conductive adhesive material 165 such as an ACF, an ACA, or the like, so as to be electrically connected to the FPCB 160. Accordingly, the connection wiring 115 may be able to electrically connect the first electrode wiring 130 and the FPCB 160. Here, the connection wiring 115 may be formed to correspond to the first electrode wiring 130 so as to be electrically connected to the first electrode wiring 130. Also, in order to be easily attached to the FPCB 160, the connection wiring 115 may be exposed from the transparent substrate 120 or the adhesive layer 150. Here, the edge of the window 110 is protruded more to the outer side than the transparent substrate 120, and the connection wiring 115 extends to the edge of the window 110 protruded more to the outer side than the transparent substrate 120. As a result, the connection wiring 115 extends from a portion connected to the first electrode wiring 130 to the edge of the window 110, whereby the connection wiring 115 is formed to be protruded more to the outer side in comparison to the transparent substrate 120.

Meanwhile, the connection wiring 115 may be formed on the print portion 113 such that the user cannot recognize it. Also, Like the first and second electrode wirings 130 and 140, the connection wiring 115 may be made of copper (Cu), aluminum (Al), gold (Au), silver (Ag), titanium (Ti), palladium (Pd), chromium (Cr), or any combination thereof, having excellent electric conductivity. Besides, the connection wiring 115 may also be made of metallic silver generated by exposing and developing a silver halide emulsion layer, indium tin oxide (ITO), PEDOT/PSS, carbon nanotube (CNT), graphene, zinc oxide (Zn0), Al-doped zinc oxide (AZO), or the like.

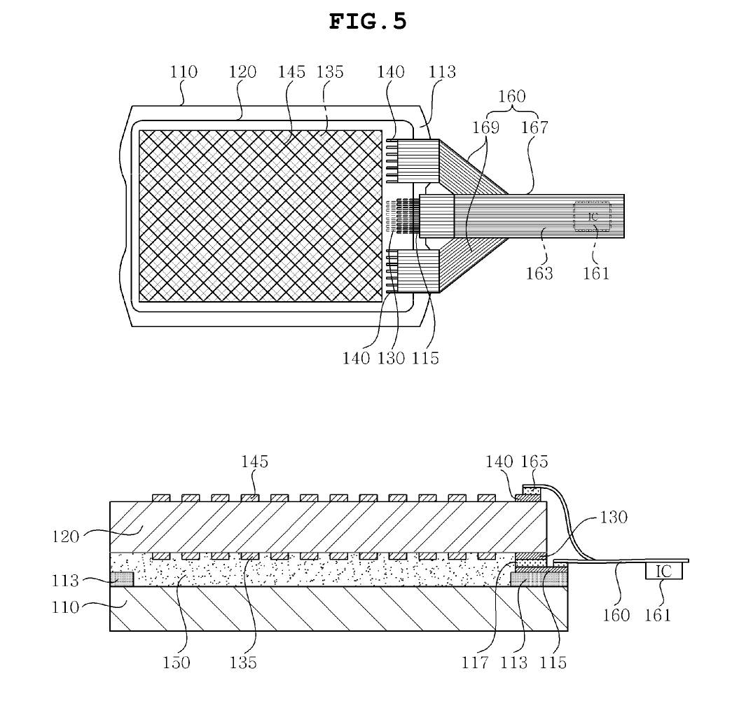

The FPCB 160 serves to electrically connect the second electrode wiring 140 and the connection wiring 115 to the IC 161. Here, the FPCB 160 may be attached to a second adhesive conductive material 165 such as an ACF, an ACA, or the like, so as to be electrically connected to the second electrode wiring 140 and the connection wiring 115. Also, the IC 161 may be mounted at the end of the FPCB 160. The IC 161 may be electrically connected to the second electrode wiring 140 and the connection wiring 115 through a conductive trace 163 (See FIG. 5).

Here, the second electrode wiring 140 formed on the other surface of the transparent substrate 120 and the connection wiring 115 formed on one surface of the window 110 are exposed in the same direction (in a downward direction), so the FPCB 160 can be electrically connected to the second electrode wiring 140 and the connection wiring 115 by using only one surface of the FPCB 160. Thus, the conductive trace 163 may only need to be formed on only one surface of the FPCB 160, saving manufacturing costs of the FPCB 160.

Also, since the second electrode wiring 140 and the connection wiring 115 are exposed in the same direction, the FPCB 160 can be electrically connected to the second electrode wiring 140 and the connection wiring 115 without being severely bent. Thus, no cracks, or the like, will be formed in the FPCB 160 and the conductive trace 163 can be prevented from being disconnected. In addition, since the second electrode wiring 140 and the connection wiring 115 are exposed in the same direction, the transparent substrate 120 is not required to be reversed when the FPCB 160 is attached to the second electrode wiring 140 and the connection wiring 115. Thus, the process of attaching the FPCB 160 can be simplified, and the process of applying the second conductive adhesive material 165 needs only to be performed once.

In addition, since the connection wiring 115 connected to the first electrode wiring 130 is exposed from the transparent substrate 120 and the adhesive layer 150, there is no need to insert the FPCB 160 between the adhesive layer 150 and the transparent substrate 120 in order to electrically connect the FPCB 160 to the first electrode wiring 130. Thus, a phenomenon in which the adhesive layer 150 and the transparent substrate 120 are not completely attached to each other due to the FPCB 160 can be prevented beforehand.

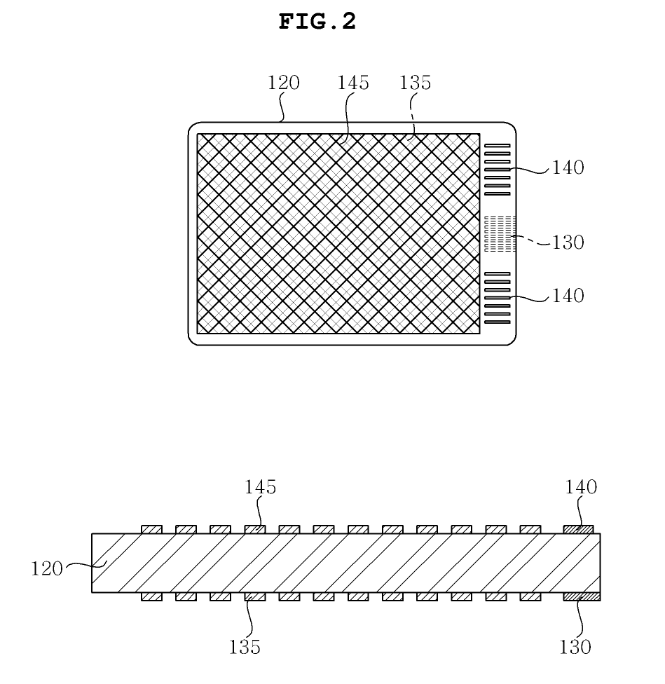

FIGS. 2 through 5 are bottom views and cross-sectional views illustrating a process of manufacturing the touch panel according to the preferred embodiment of the present invention. A process of electrically connecting the FPCB 160 to the second electrode wiring 140 and the connection wiring 115 will be described with reference to FIGS. 2 through 5.

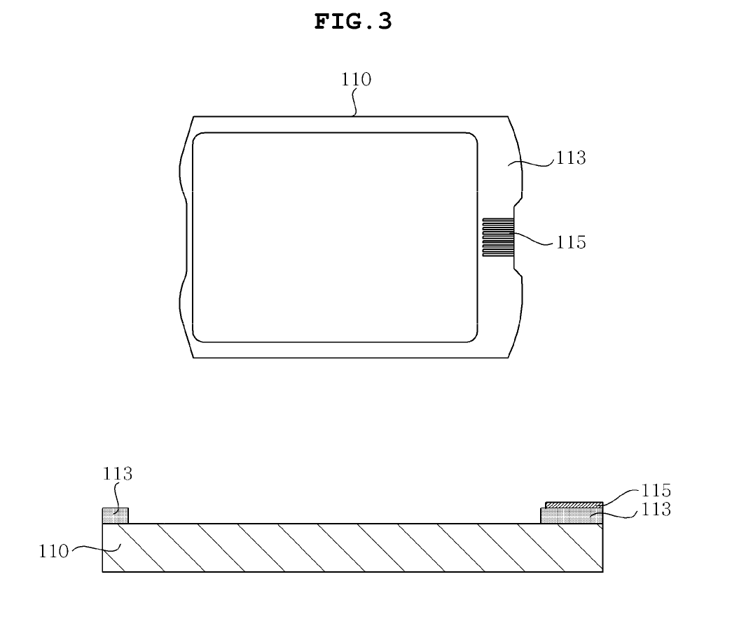

First, as shown in FIGS. 2 and 3, the transparent substrate 120 on which the first and second electrode patterns 135 and 145 and the first and second electrode wirings 130 and 140 are formed is prepared (See FIG. 2), and the window 110 on which the connection wiring 115 is formed is prepared (See FIG. 3). Here, the connection wiring 115 of the window 110 is formed to correspond to the first electrode wiring 130 of the transparent substrate 120.

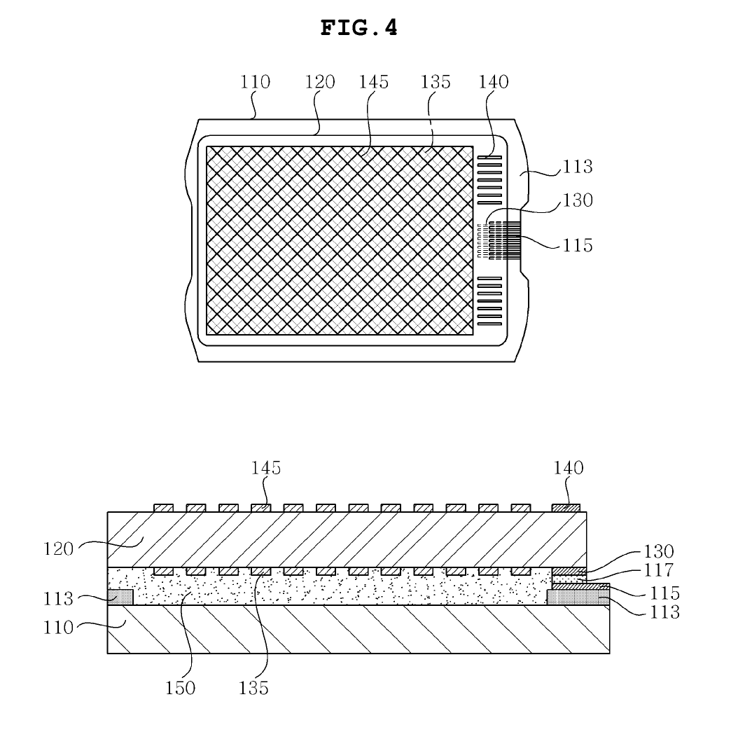

Next, as shown in FIG. 4, the transparent substrate 120 and the window 110 are attached to each other by the adhesive layer 150. Here, the connection wiring 115 is electrically connected to the first electrode wiring 130 and extends to the edge of the window 110 so as to be exposed from the transparent substrate 120. Thereafter, a degassing process of removing bubbles between the adhesive layer 150 and the window 110 or between the adhesive layer 150 and the transparent substrate 120 may be performed within an autoclave.

And then, as shown in FIG. 5, the FPCB 160 is electrically connected to the second electrode wirings 140 and the connection wiring 115. Here, since the second electrode wirings 140 and the connection wiring 115 are exposed in the same direction, only one surface of the FPCB 160 needs to be electrically connected to the second electrode wirings 140 and the connection wiring 115. Also, since the FPCB 160 is not severely bent, the generation of cracks in the FPCB 160 can be prevented. In addition, as mentioned above, since the process of attaching the FPCB 160 can be performed after performing the degassing process within the autoclave, the FPCB 160 and the IC 161 can be prevented from being pressed and heated and damaged within the autoclave.

Meanwhile, any types of FPCBs known in the art may be used as the FPCB 160. For example, a fork type FPCB including a base portion 167 and two protrusions 169 protruded from both sides of the base portion 167 may be used (See the bottom view of FIG. 5). Here, one end of the base portion 167 may be electrically connected to the connection wiring 115, and one end of each of the two protrusions 169 may be electrically connected to the second electrode wirings 140. In this case, the connection wiring 115 is formed at the center of the edge of the window 110 to correspond to the base portion 167, and the second electrode wirings 140 are formed at both sides of the connection wiring 115 to correspond to the two protrusions 169.

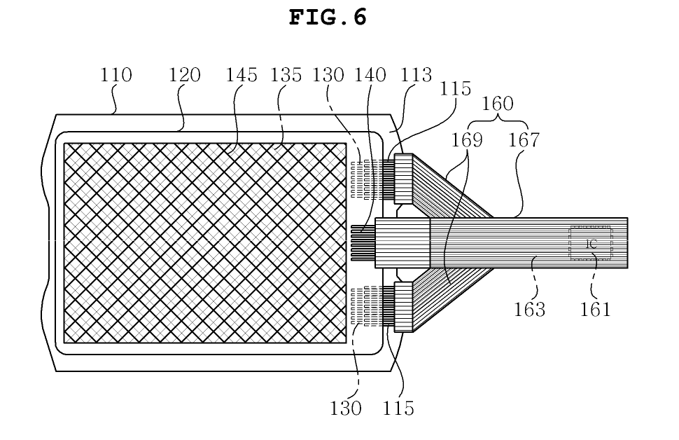

Here, one end of the base portion 167 does not need to be necessarily electrically connected to the connection wiring 115 and one end of each of the two protrusions 169 does not need to be necessarily electrically connected to the second electrode wirings 140. For example, as shown in FIG. 6, one end of the base portion 167 may be electrically connected to the second electrode wiring 140 and one end of each of the two protrusions 169 may be electrically connected the connection wirings 115. In this case, the second electrode wiring 140 is formed at the center of the edge of the transparent substrate 120 to correspond to the base portion 167, and the connection wirings 115 may be formed at both sides of the second electrode wiring 140 to correspond to the two protrusions 169.

Meanwhile, the touch panel 100 (See FIG. 1) according to the present embodiment has a dual-layer structure in which the first and second electrode patterns 135 and 145 are formed on both surfaces of the transparent substrate 120. Thus, the touch panel 100 according to the present embodiment may be used as a capacitive type touch panel.

According to the preferred embodiments of the present invention, since the connection wiring is formed on one surface of the window and connected to the electrode wirings, the FPCB can be electrically connected to the electrode wirings formed on both surfaces of the transparent substrate without being severely bent. Thus, generation of cracks, or the like, in the FPCB can be prevented.

Also, according to the preferred embodiments of the present invention, since the FPCB is electrically connected to the electrode wirings formed on both surfaces of the transparent substrate by using the connection wiring formed on one surface of the window, the FPCB can be attached thereto without reversing the transparent substrate. Thus, the process of attaching the FPCB can be simplified and the process of applying the ACF or the ACA can be performed at one time.

In addition, since the connection wiring formed on one surface of the window is exposed from the transparent substrate or the adhesive layer, even after the window and the transparent substrate are attached with the adhesive layer and subjected to a degassing process within an autoclave, the process of attaching the FPCB can be performed. Thus, the FPCB or an IC (which is mounted on the FPCB) can be prevented from being pressed and heated and thus damaged through the degassing process within the autoclave.

Although the preferred embodiments of the present invention have been disclosed for illustrative purposes, they are for specifically explaining the present invention and thus a touch panel according to the present invention is not limited thereto, but those skilled in the art will appreciate that various modifications, additions and substitutions are possible, without departing from the scope and spirit of the invention as disclosed in the accompanying claims.

What is claimed is:

1. A touch panel comprising:
a window;
a transparent substrate;
a first electrode wiring formed on one surface of the transparent substrate;
a second electrode wiring formed on the other surface of the transparent substrate;
an adhesive layer attaching one surface of the window to one surface of the transparent substrate;
a connection wiring formed on one surface of the window and electrically connected to the first electrode wiring; and
a flexible printed circuit board (FPCB) electrically connected to the second electrode wiring and the connection wiring.

2. The touch panel as set forth in claim 1, wherein the connection wiring is attached to an anisotropic conductive film (ACF) or an anisotropic conductive adhesive (ACA) so as to be electrically connected to the first electrode wiring.

3. The touch panel as set forth in claim 1, wherein the FPCB is attached to an ACF or an ACA so as to be electrically connected to the second electrode wiring and the connection wiring.

4. The touch panel as set forth in claim 1, wherein the connection wiring extends to the edge of the window so as to be protruded more to the outer side than the transparent substrate.

5. The touch panel as set forth in claim 1, wherein one surface of the FPCB is electrically connected to the second electrode wiring and the connection wiring.

6. The touch panel as set forth in claim 1, wherein the FPCB includes:
a base portion; and
two protrusions protruded from both sides of the base portion.

7. The touch panel as set forth in claim 6, wherein one end of the base portion is electrically connected to the connection wiring, and one end of each of the two protrusions is electrically connected to the second electrode wirings.

8. The touch panel as set forth in claim 6, wherein one end of the base portion is electrically connected to the second electrode wiring, and one end of each of the two protrusions is electrically connected to the connection wirings.

9. The touch panel as set forth in claim 1, wherein the adhesive layer is an optical clear adhesive (OCA).

10. The touch panel as set forth in claim 1, further comprising:
a first electrode pattern formed on one surface of the transparent substrate; and
a second electrode pattern formed on the other surface of the transparent substrate,
wherein the first electrode wiring is connected to the first electrode pattern and the second electrode wiring is connected to the second electrode pattern.

11. The touch panel as set forth in claim 10, wherein the first electrode wiring is integrally formed with the first electrode pattern, and the second electrode wiring is integrally formed with the second electrode pattern.

12. The touch panel as set forth in claim 10, wherein the first and second electrode patterns are made of copper (Cu), aluminum (Al), gold (Au), silver (Ag), titanium (Ti), palladium (Pd), chromium (Cr), or any combination thereof.

13. The touch panel as set forth in claim 10, wherein the first and second electrode patterns are made of metallic silver generated by exposing and developing a silver halide emulsion layer.
